(19) United States
(12) Patent Application Publication
(10) Pub. No.: US 2020/0118780 A1
(43) Pub. Date: Apr. 16, 2020

(54) PROTECTION DEVICE FOR AN ELECTRICAL DISTRIBUTION SYSTEM OF AN AIRCRAFT ELECTRICAL NETWORK

(71) Applicant: ZODIAC AERO ELECTRIC, Montreuil (FR)

(72) Inventor: Stéphane Guenot, Montreuil (FR)

(21) Appl. No.: 16/624,277

(22) PCT Filed: Jun. 19, 2018
(86) PCT No.: PCT/FR2018/051460

§ 371 Date: Dec. 18, 2019

(30) Foreign Application Priority Data
Jun. 19, 2017 (FR) 1755547

(51) Int. Cl. H01H 69/02; H01H 85/02; H01H 85/08; H01H 85/06; H01H 85/12

(52) U.S. Cl. CPC H01H 69/022; H01H 85/0241; H01H 85/12; H01H 85/06; H01H 85/08

(57) ABSTRACT

The invention relates to a protection device (1) for an electrical distribution system (3) of an aircraft electrical network, said device (1) including a substrate (11) comprising a plurality of electrically conductive elements (13), said electrically conductive elements (13) being connected pairwise by a fuse element (15), and a coating material (17) that is arranged over the substrate (11) and each fuse element (15). The invention also relates to an electrical distribution system (3) of an aircraft electrical network comprising an electrical circuit (5) to which one or more protection devices (1) are attached, said one or more protection devices (1) being electrically connected to the electrical circuit (5).

### CROSS-REFERENCE TO RELATED APPLICATIONS

The present disclosure is a 371 application of International Application No. PCT/FR2018/051460, filed Jun. 19, 2018, which claims benefit of French Application No. 1755547, filed Jun. 19, 2017, the contents of which are incorporated herein by reference in its entirety.

### FIELD OF THE TECHNOLOGY

The invention relates to a protection device for an electrical distribution system of an aircraft electrical network and an electrical distribution system comprising one or more protection devices.

### BACKGROUND

The electrical distribution system of an aircraft electrical network includes one or more protection devices. These protection devices can be in the form of electromechanical circuit breakers or static switches, such as semiconductor-based switches such as SSPCs or “Solid State Power Controllers”. These protection devices can be completed by one or more fuse elements. In particular, in the case of semiconductors such as SSPCs, the latter are associated with one or more fuse elements ensuring opening in the event of a failure of said semiconductor. This is because said semiconductors have a failure mode that is incompatible with the main function of opening the electrical circuit in the event of the presence of a fault.

The fuse element is chosen according to the service voltage delivered, the time allotted for opening in the event of a fault, the breaking capacity and the shape of the fusing curve. The fusing curve corresponds to a graph of threshold current as a function of time, ensuring, for any current beyond the current fixed by said graph, the opening of the supply network line.

Fuse elements responding to problems imposed by the use of protection devices such as the electromechanical circuit breakers or static switches are generally fuse elements of the cartridge type or fuse elements proposed by the SSPC manufacturer.

However, these types of fuse elements exhibit a large size associated with a fitting complexity, a poorly controlled positioning of the fusing curve and an impossibility to replace the fuses.

There is therefore a need to provide a protection device that does not exhibit the abovementioned drawbacks.

### BRIEF SUMMARY

According to a first aspect, a subject of the invention is a protection device for an electrical distribution system of an aircraft electrical network, said device including a substrate comprising a plurality of electrical conducting elements, said electrical conducting elements being connected pairwise by a fuse element, and a coating material arranged on the substrate and each fuse element.

The invention provides for:
controlling the fusing curve and adapting the latter according to need;
separating the process of manufacturing the fuse element as such from the substrate receiving said element, such as for example an electronic board;
manufacturing components and replacing them easily and at low cost, using standard fitting and removal means;
limiting and adjusting the size according to thermal constraints imposed on the fuse elements.

According to particular modes of the invention, the device of the invention can comprise one or more of the following characteristics taken in isolation or in all possible combinations:
one or more electrical conducting elements are made from copper or alumina;
the fuse elements are made from alloys or fusible materials, such as aluminum, copper, gold, tin or lead;
at least one fuse element comprises a plurality of wire-based fuse elements;
at least one fuse element comprises a fuse element of the cylindrical or parallelepiped strip type;
the coating material is an epoxy resin or a gel;
the device of the invention additionally comprises a protective envelope fitted on the coating material;
the substrate includes silica powder.

According to another aspect, another subject of the invention is an electrical distribution system of an aircraft electrical network comprising an electrical circuit on which one or more protection fuse devices are fixed, the protection fuse device or devices being electrically connected to the electrical circuit.

Preferably, an area where electrical components are not fitted is arranged around the protection fuse device or devices.

### BRIEF DESCRIPTION OF THE SEVERAL VIEWS OF THE DRAWINGS

Other aims, features and advantages of the invention will emerge from reading the following description, given purely by way of nonlimiting example, and with reference to the accompanying drawings in which:

FIG. 1 is a schematic view from above of an embodiment of the device of the invention fitted on a receiving electrical circuit;

FIG. 2 is a partial schematic view from above of a substrate of the embodiment of FIG. 1 comprising several electrical conductors without fuses;

FIG. 3 is a partial exploded schematic view from above of the embodiment of FIG. 2;

FIG. 4 is a partial assembled schematic view from above of the embodiment of FIG. 2;

FIG. 5 is a partial assembled schematic view from beneath of the embodiment mode of FIG. 2;

FIG. 6 is a partial schematic view from above of an embodiment of the invention comprising a substrate, two electrical conductors and a fuse element of the parallelepiped strip type;

FIG. 7 is a flow chart corresponding to a fitting method for the embodiment of FIG. 1;

FIG. 8 is a flow chart corresponding to a removal method for the embodiment of FIG. 1.

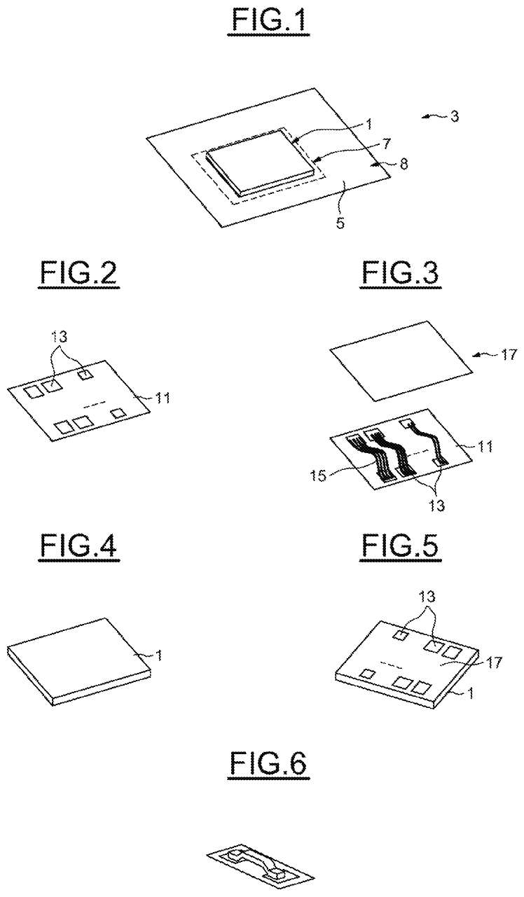

### DETAILED DESCRIPTION

As illustrated in the figures, the protection device 1 of the invention provides for protecting an electrical distribution system 3 of an aircraft electrical network (not represented). The electrical network can be a low-voltage electrical network.

Thus, the device of the invention enables effective protection against short-circuits or overloads.

The electrical distribution system of the invention 3 comprises an electrical circuit 5 on which one or more devices of the invention are fixed. The device or devices of the invention 1 are electrically connected to the electrical circuit 5.

According to one embodiment, an area 7 where electrical components are not fitted is reserved around the device or devices of the invention 1. Said non-fitted area 7 provides for facilitating any separation of the device of the invention 1 from the electrical circuit. Said area 7 exhibits an appropriate shape, in particular a shape that is substantially complementary to the external shape of the device of the invention 1.

The device of the invention 1 includes a substrate 11 comprising a plurality of electrical conducting elements 13. By way of nonlimiting examples of electrical conducting elements, mention can be made of wire bonding, ribbon bonding, screen printing paste and cutout metal sheet type elements, or more generally any element of controlled geometric characteristics, and of an electrical conductor having the main property of changing state in the event of significant heating.

Said electrical conducting elements 13 are connected pairwise by a fuse element 15 and a coating material 17 arranged on the substrate 11 and each fuse element 13.

By virtue of the invention, it is possible to:
control the fusing curve and adapt the latter according to need;
manufacture components and replace them easily and at low cost, using standard fitting and removal means;
limit and adjust the size according to thermal constraints imposed on the fuse elements.

Preferably, one or more electrical conducting elements 13 are made from copper or alumina.

Advantageously, the substrate 11 can be a printed circuit type substrate, thereby providing for optimizing the mass and the cost of producing the protection device 1 of the invention. The substrate 11 can also be the Direct Bonding Copper type.

According to one embodiment, the fuse elements 15 can be made from alloys or fusible materials, such as aluminum, copper, gold, tin or lead. The nature of the fuse element used is chosen according to expected performance.

According to one embodiment, at least one fuse element 15 comprises a plurality of wire-based fuse elements as illustrated in FIG. 3, or cylindrical or parallelepiped strip fuse elements, as illustrated in FIG. 6.

Thus, advantageously, the fusing curve of said fuse elements 15 can be produced by using a single geometry of the elementary fuse element thereby facilitating the method of the invention.

According to one embodiment, the coating material 17 is a material having a coating function and/or a mechanical protection function. By way of example, mention can be made of an epoxy resin, such as the resins used in microelectronics according to the dam and fill method.

There can also be a gel such as those used during the manufacture of power electronics components.

The coating material 17 provides for advantageously absorbing the energy generated by the blowout of the fuse element or elements 15. Said coating material 17 also contributes to the control of the fusing curve.

According to yet another embodiment (not represented), the device of the invention can additionally include a protective envelope fitted on said coating material 17. Such a protective envelope provides for rigidizing the device of the invention 1. By way of example, mention can be made of a ceramic or plastic cover, a gel or a varnish.

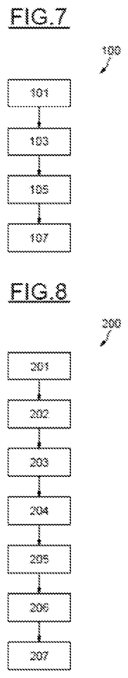

As illustrated in FIG. 7, the flow chart 100 illustrates an embodiment of an embodiment of a device of the invention fitted on a receiving electronic circuit.

In step A 101, the receiving electronic circuit and the device of the invention are first assembled in a drying kiln to be heated to a temperature enabling the moisture contained in said receiving circuit to be removed.

In step B 103, a method for producing the electrical circuit is applied to the parts 8 of the circuit 5 that are not occupied by the device of the invention 1 and not contained in the area 7. The production method can be a screen printing method. In that case, the area to screen print receives a paste to be soldered.

In step C 105, the device of the invention is fitted to the receiving circuit of the device either manually or with the aid of a fitting machine.

In step D 107, the assembly comprising the device of the invention and the receiving circuit is then heated by an oven in which the heat makes the paste to be soldered melt in order to make it join, notably heated in an oven.

As illustrated in FIG. 8, the flow chart 200 illustrates an embodiment for the removal of the device of the invention fitted on a receiving electronic circuit.

In step E 201, the receiving electronic circuit assembly containing the device of the invention is placed in a drying kiln to remove the moisture in said assembly, notably in a heated oven.

In step F 202, the receiving circuit assembly containing the device of the invention is preheated in order to facilitate removal.

In step G 203, the device of the invention is separated from the receiving electronic circuit with a machine comprising a heated nozzle adapted to the size of the device of the invention. The use of such a nozzle provides for removing said device without damaging the receiving electronic circuit. The nozzle arrives at being placed around the device of the invention, at the non-fitted area 7. Thus, the nozzle can have a diameter of between 3×3 mm and 45×45 mm.

In step H 204, the area made bare following removal of the device of the invention is cleaned.

In step I 205, the receiving circuit of the invention is screen printed. The receiving area of the invention receives a paste to be soldered.

In step J 206, the new device of the invention is fitted to the receiving circuit, according to the same method as that described at step C 104.

In step K 207, and according to the same usage mode, a heated nozzle machine is used to secure the device of the invention to the receiving electronic circuit.

1. A protection device (1) for an electrical distribution system (3) of an aircraft electrical network, said device (1) including a substrate (11) comprising a plurality of electrical conducting elements (13), said electrical conducting elements (13) being connected pairwise by a fuse element (15), and a coating material (17) arranged on the substrate (11) and each fuse element (15).

2. The device (1) of claim 1, in which one or more electrical conducting elements (13) are made from copper or alumina.

3. The device (1) of claim 1, in which the fuse elements (15) are made from alloys or fusible materials, such as aluminum, copper, gold, tin or lead.

4. The device (1) of claim 1, in which at least one fuse element (15) comprises a plurality of wire-based fuse elements.

5. The device (1) of claim 1, in which at least one fuse element (15) comprises a fuse element of the cylindrical or parallelepiped strip type.

6. The device (1) of claim 1, in which the coating material (17) is an epoxy resin or a gel.

7. The device (1) of claim 1, additionally comprising a protective envelope fitted on the coating material (17).

8. The device (1) of claim 1, in which the substrate (11) includes silica powder.

9. An electrical distribution system (3) of an aircraft electrical network, comprising an electrical circuit (5) on which one or more protection devices (1) are fixed as claim 1, the one or more protection devices (1) being electrically connected to the electrical circuit (5).

10. The system (3) of claim 9, in which an area (7) where electrical components are not fitted is arranged around the one or more protection devices (1).
